(19) United States
(12) Patent Application Publication
(10) Pub. No.: US 2026/0103149 A1
(43) Pub. Date: Apr. 16, 2026

(54) POWER OPEN, CLOSE AND CINCHING GLOVE BOX

(71) Applicant: Inteva Products, LLC, Troy, MI (US)

(72) Inventors: Brian Staser, Oxford, MI (US); Kevin VanDevender, Lapeer, MI (US)

(21) Appl. No.: 19/360,374

(22) Filed: Oct. 16, 2025

Related U.S. Application Data
(60) Provisional application No. 63/708,076, filed on Oct. 16, 2024.

(51) Int. Cl. B60R 7/06; E05F 15/627

(52) U.S. Cl. CPC B60R 7/06; E05F 15/627; E05Y 2201/654

(57) ABSTRACT

A vehicle glove box assembly, including: a glove box surround; a glove box compartment, the glove box compartment being pivotally mounted to the glove box surround for movement between a fully closed position where the glove box compartment is sealed against the glove box surround and a fully opened position where an internal volume of the glove box compartment is accessible and a secondary position wherein the glove box compartment is latched and located between the fully closed position and the fully opened position; and a driving mechanism for moving the glove box compartment between the fully closed position and the fully opened position, the driving mechanism being a push/pull cable drive system.

### CROSS REFERENCE TO RELATED APPLICATIONS

The present application claims the benefit of U.S. Provisional Patent Application 63/708,076 filed on Oct. 16, 2024, the entire contents of which are incorporated herein by reference thereto.

### BACKGROUND

Exemplary embodiments of the present disclosure pertain to the art of vehicle glove boxes.

A dashboard also called as an instrument panel (IP) or fascia, also acts as the control panel of the vehicle. A glove compartment or a vehicle glove box is a compartment built into the dashboard, located over the front-seat passenger's footwell. It is often used for miscellaneous storage.

Typically a vehicle glove box includes a mechanical device by which the glove box can be opened and closed manually by the user. However, with improvements in vehicle technology and to improve user experiences it is desirable to fully automate the opening and closing operations of a vehicle glove box.

In order to reduce any buzz, squeak or rattle of the glove box during vehicle vibration/motion, it is desirable to have the glove box cinched tight against seals. Hence, it is also desired that automation of the closing and opening of the vehicle glove box incorporates or is integrated with a cinching function for reduction of noise. In addition, it is also desirable that the glove box can be closed manually if desired.

### BRIEF DESCRIPTION

Disclosed is a vehicle glove box assembly, including: a glove box surround; a glove box compartment, the glove box compartment being pivotally mounted to the glove box surround for movement between a fully closed position where the glove box compartment is sealed against the glove box surround and a fully opened position where an internal volume of the glove box compartment is accessible and a secondary position wherein the glove box compartment is latched and located between the fully closed position and the fully opened position; and a driving mechanism for moving the glove box compartment between the fully closed position and the fully opened position, the driving mechanism being a push/pull cable drive system.

In addition to one or more of the features described above, or as an alternative to any of the foregoing embodiments, the push/pull cable drive system includes a pair of separate cables for moving the glove box compartment between the fully closed position and the fully opened position.

In addition to one or more of the features described above, or as an alternative to any of the foregoing embodiments, the pair of separate cables control both ends of the glove box compartment simultaneously.

In addition to one or more of the features described above, or as an alternative to any of the foregoing embodiments, at least one of the pair of separate cables has a cable end fitting configured to engage a flexible tab of the glove box compartment.

In addition to one or more of the features described above, or as an alternative to any of the foregoing embodiments, the cable end fitting has an angled surface to configured to engage an angled surface of the flexible tab of the glove box compartment.

In addition to one or more of the features described above, or as an alternative to any of the foregoing embodiments, a switch is configured to be actuated by the flexible tab of the glove box compartment.

In addition to one or more of the features described above, or as an alternative to any of the foregoing embodiments, the pair of separate cables each have a cable end fitting configured to be slidably received within a groove of the glove box compartment.

In addition to one or more of the features described above, or as an alternative to any of the foregoing embodiments, at least one of the pair of separate cables has a cable end fitting configured to engage a flexible tab of the glove box compartment and the flexible tab has a protruding portion configured to engage a closing tab of the glove box surround.

In addition to one or more of the features described above, or as an alternative to any of the foregoing embodiments, the cable end fitting has an angled surface to configured to engage an angled surface of the flexible tab of the glove box compartment.

In addition to one or more of the features described above, or as an alternative to any of the foregoing embodiments, the protruding portion and the angled surface are located on opposite sides of the flexible tab.

In addition to one or more of the features described above, or as an alternative to any of the foregoing embodiments, the pair of separate cables are received within a cable race of a structure that secured to the glove box surround.

In addition to one or more of the features described above, or as an alternative to any of the foregoing embodiments, the structure and the pair of separate cables are covered with a shroud.

In addition to one or more of the features described above, or as an alternative to any of the foregoing embodiments, the pair of separate cables control both ends of the glove box compartment simultaneously.

In addition to one or more of the features described above, or as an alternative to any of the foregoing embodiments, at least one of the pair of separate cables has a cable end fitting configured to engage a flexible tab of the glove box compartment.

In addition to one or more of the features described above, or as an alternative to any of the foregoing embodiments, the cable end fitting has an angled surface to configured to engage an angled surface of the flexible tab of the glove box compartment.

In addition to one or more of the features described above, or as an alternative to any of the foregoing embodiments, a switch is configured to be actuated by the flexible tab of the glove box compartment.

In addition to one or more of the features described above, or as an alternative to any of the foregoing embodiments, the pair of separate cables control both ends of the glove box compartment simultaneously and the pair of separate cables each have a cable end fitting configured to be slidably received within a groove of the glove box compartment.

In addition to one or more of the features described above, or as an alternative to any of the foregoing embodiments, the cable end fitting of at least one of the pair of separate cables is configured to engage a flexible tab of the glove box compartment and the flexible tab has a protruding portion configured to engage a closing tab of the glove box surround.

In addition to one or more of the features described above, or as an alternative to any of the foregoing embodiments, the cable end fitting the cable end fitting of at least one of the pair of separate cables has an angled surface to configured to engage an angled surface of the flexible tab of the glove box surround.

In addition to one or more of the features described above, or as an alternative to any of the foregoing embodiments, the protruding portion and the angled surface are located on opposite sides of the flexible tab.

### BRIEF DESCRIPTION OF THE DRAWINGS

The following descriptions should not be considered limiting in any way. With reference to the accompanying drawings, like elements are numbered alike:

FIG. 1 is a top left front perspective view of a vehicle glove box assembly which is shown in its fully opened position;

FIG. 2 is a rear left side perspective view of a vehicle glove box assembly which is shown in its fully opened position;

FIG. 3 illustrates portions of the driving mechanism for the vehicle glove box assembly illustrated in FIGS. 1 and 2 without a surrounding structure;

FIGS. 4A-4C illustrate portions of a manual override of the vehicle glove box assembly of the present disclosure;

FIGS. 5A-5C illustrate retainment of the vehicle glove box assembly in a secondary closed position in accordance with the present disclosure;

FIGS. 6-11 illustrate additional views of the vehicle glove box assembly or portions thereof;

FIG. 12 illustrates the vehicle glove box assembly in a closed position;

FIG. 13 illustrates the vehicle glove box assembly in an open position; and

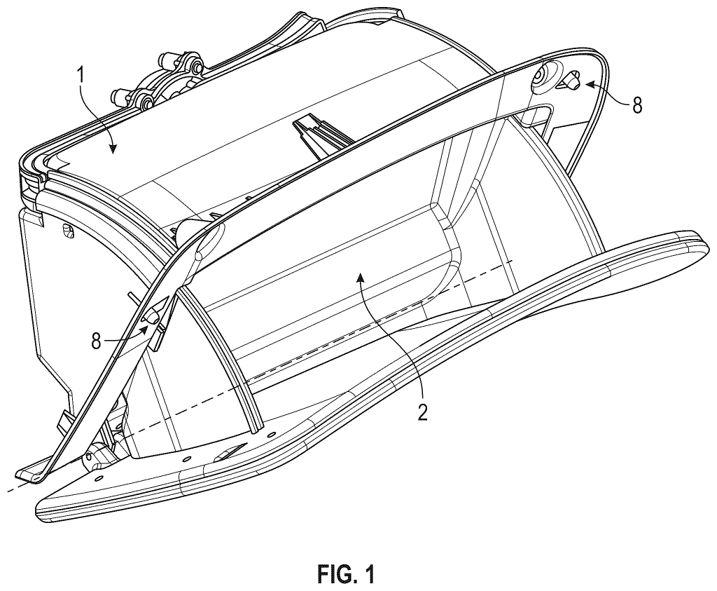

Appendix I is a color version of FIGS. 1-13.

### DETAILED DESCRIPTION

A detailed description of one or more embodiments of the disclosed apparatus and method are presented herein by way of exemplification and not limitation with reference to the Figures.

FIG. 1 illustrates a complete vehicle glove box assembly which is shown in its fully open position. The glove box assembly includes a glove box surround 1 which houses the moving compartment or other wise known as the glove box compartment 2. The glove box surround 1 is fixed to the dashboard of the vehicle. The glove box compartment 2 can be rotated to provide at least two primary positions; the first is a fully closed position where the glove box compartment is sealed closed thus securing its luggage while the second fully opened position is where the maximum volume of the glove box is accessible by the user.

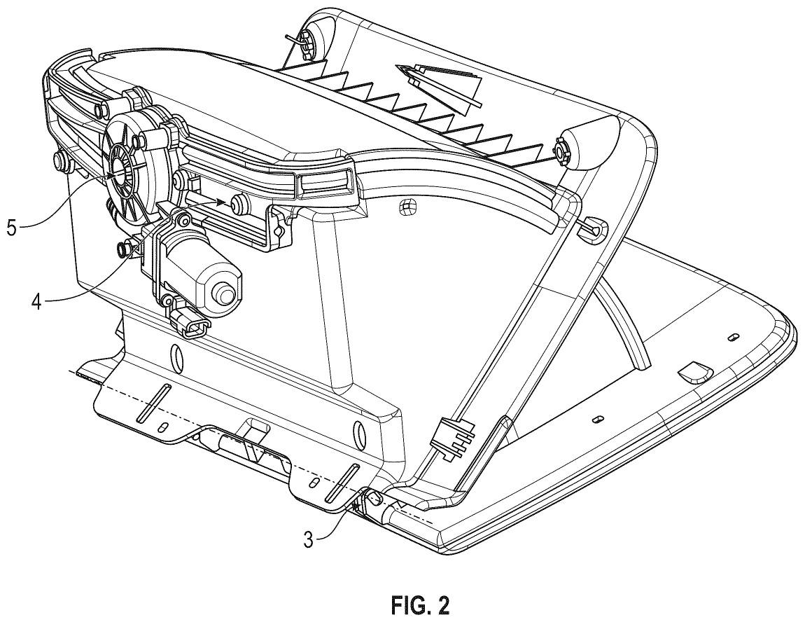

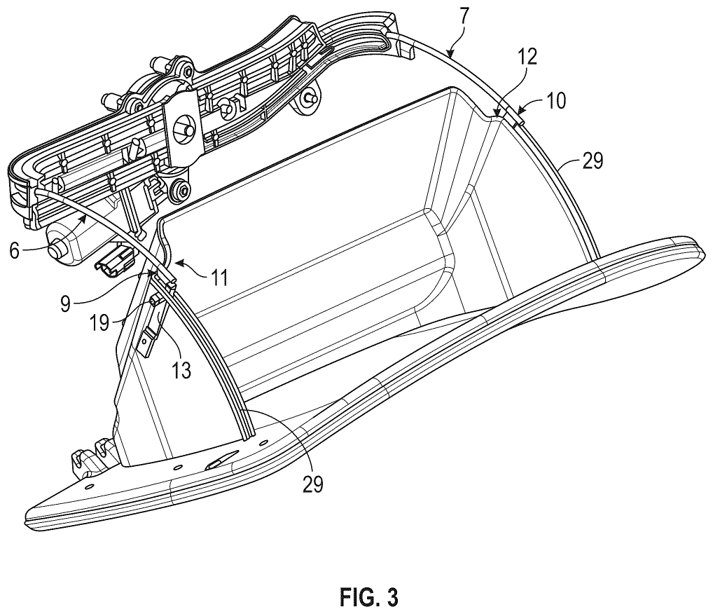

Glove box compartment 2 rotates about pivot pins 3 shown in FIG. 2 to transform between the two primary positions. In the illustrated, non limiting embodiment a push/pull cable drive system 4 is used to transfer motion from a motor 5 to the glove box 2. FIG. 3 shows two separate cables 6, 7 that are used to control both ends of the glove box simultaneously. When a signal is received from an external source, the motor 5 pushes the cables 6, 7 to lower the glove box 2. The glove box 2 will naturally be inclined to open on its own due to gravity, but can be pushed with a limited force by the cables if needed to overcome any stiction that may exist.

When a signal is received from an external source to close the glove box 2, the motor 5 pulls the cables 6, 7 to close the glove box 2. Closing the glove box 2 with a cable at each end ensures that the glove box 2 is cinched shut with balanced load on all bumpers 8.

The cables 6, 7 induce a closing and cinching load on the glove box 2 through respective cable end fittings 9 and 10. The cable end fittings 9 and 10 pull on rear corners 11 and 12 of the glove box 2. By pulling on the rear corners 11 and 12 of the glove box 2, the cables 6 and 7 and cable end fittings 9 and 10 remain unseen to the system operator. In one embodiment, the cable end fittings 9 and 10 of the separate cables 6 and 7 are slidably received within a groove 29 of the glove box compartment.

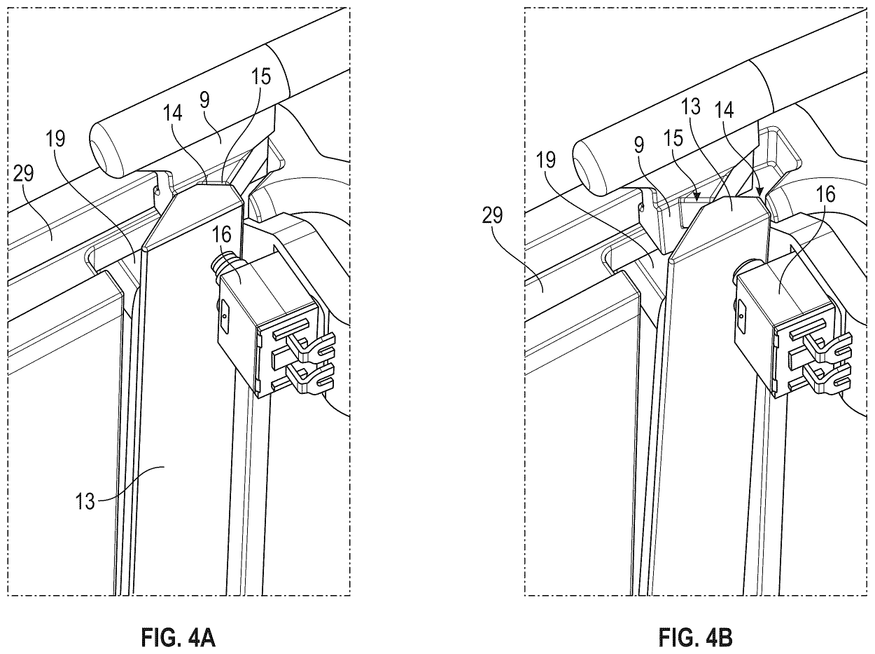

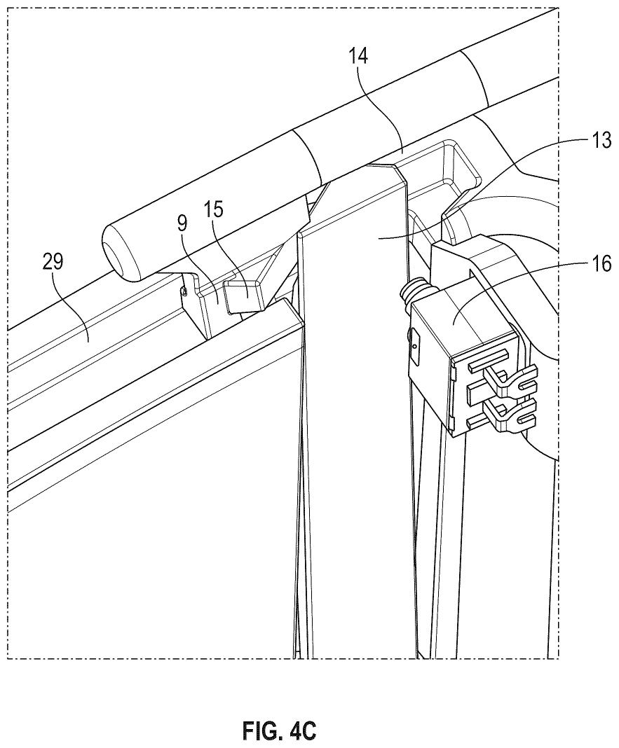

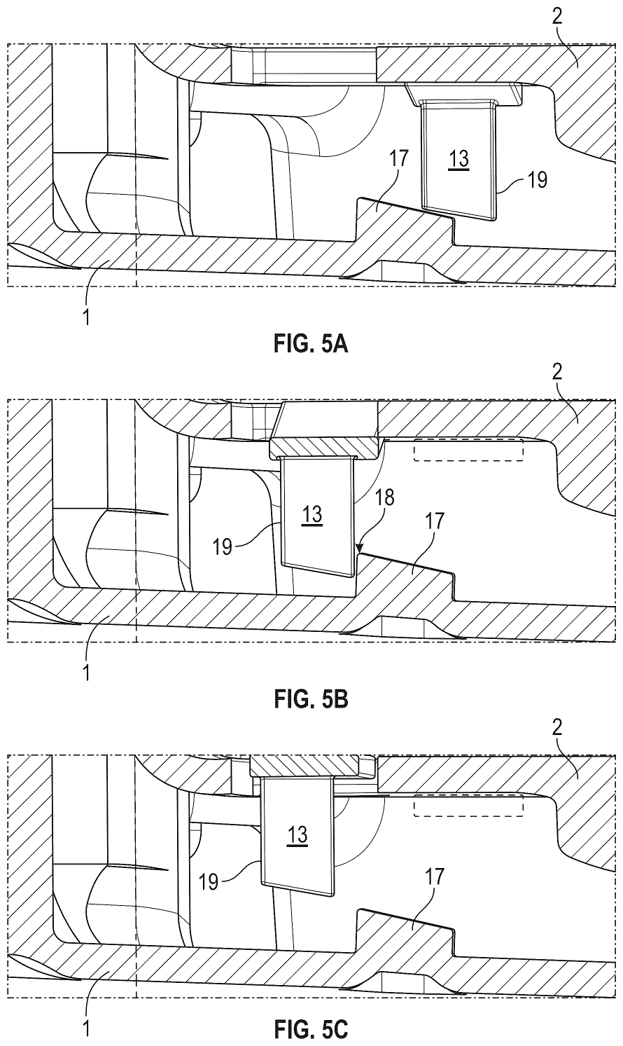

Various embodiments of the present disclosure also include the ability for the glove box 2 to be closed manually by the system operator. When the operator pushes the glove box 2 with a sufficient force a flexing tab or tab or flex tab 13 flexibly mounted to the glove box 2 deflects and disengages the cable end fitting 9 from the glove box 2 allowing it to be closed with no additional force other than that of overcoming gravity. The force required to disengage the cable end fitting 9 is fully tunable by the original equipment manufacturer (OEM) by modifying the angles of the flex tab ramp 14 and the cable end fitting ramp 15 and the stiffness of the flexing tab 13. When the flexing tab 13 flexes to release the cable end fitting 9, it also engages a switch 16 to initiate a power closing sequence with the glove box drive system. This will return the cables to a closed position and cinch the glove box 2 closed. The manual closing of the glove box 2 to a secondary closing position will engage the flex tab, tab or flexing tab 13 with a secondary closing tab 17 on the glove box surround 1 to retain the glove box 2 in a partially latched position or secondary position (e.g., closed and latched but not totally closed). See at least FIGS. 5A-5C. FIG. 4A corresponds to FIG. 5C and FIG. 4C corresponds to FIGS. 5A and 5B. In FIG. 5B, the glove box 2 is in the aforementioned secondary position (e.g., partially closed and latched but not fully closed). Once the cables 6 and 7 are moved to the fully latched position, the cable end fittings 9 and 10 will move the tab 13 to the position illustrated in at least FIG. 5C. As illustrated in at least FIGS. 5A-5C, the tab 13 has a protruding portion 19

Referring now to at least FIGS. 5A-5C, the glove box 2 is held in a secondary closed position 18 by the engagement of the flex tab 13 with the closing tab 17 that is not fully cinched. The power closing of the power drive system which was initiated by the manual closing operation will reengage the cable end fitting 9 with the flex tab 13 thus disengaging the flex tab 13 from the secondary closing tab 17 while also engaging the end fittings 9 and 10 with the rear corners 11 and 12 to cinch the glove box 2 shut. The flex tab 13 is held in a manner by cable end fitting 9 such that the flex tab 13 does not engage with the secondary closing tab 17 when a power opening signal is processed.

In one non-limiting embodiment, the glove box 2 has one flex tab, tab or flexing tab 13 and only one cable end fitting 9 engages the flex tab, tab or flexing tab 13. The other cable end fitting 10 is only needed to support the final cinching operation. Of course and in an alternative embodiment, the glove box may have two flex tabs, tabs or flexing tabs 13 on opposite sides of the glove box 2 and the cable end fittings 9 and 10 each engage a corresponding flex tab, tab or flexing tab 13. The flex tab or tabs or flexing tabs 13 may be integrally formed with the glove box 2 so that they are formed as a single unitary structure. Alternatively, the flex tab or tabs 13 are separately secured to the glove box 2. The flex tab or tabs 13 may be formed of resilient material such that as the flex tab or tabs 13 are deflected from an initial position to second position by a biasing force and once the biasing force is removed the resilient material returns the flex tab or tabs 13 to the initial unbiased position.

The cable drive system 4 can also be isolated from the glove box surround 1 with a vibration dampening pad (not shown) to reduce any noise that may be generated by the vibration of the drive system 4 while engaged with the glove box surround 1.

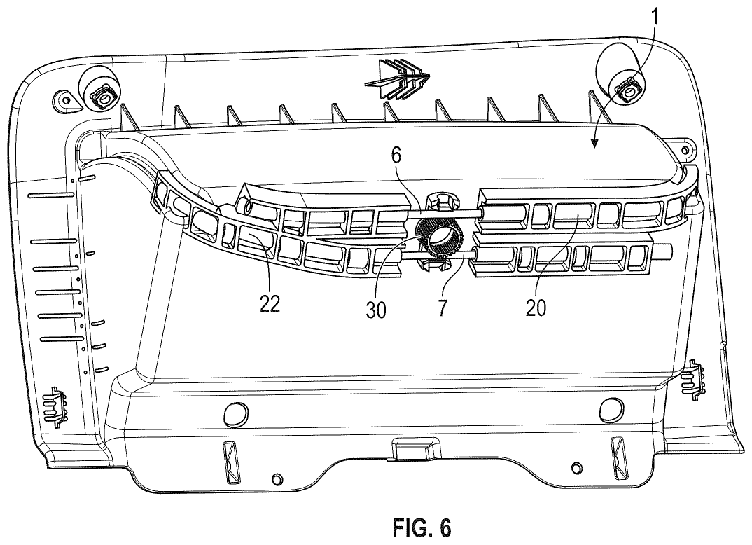

FIGS. 6-11 additional views of the vehicle glove box assembly or portions thereof are illustrated.

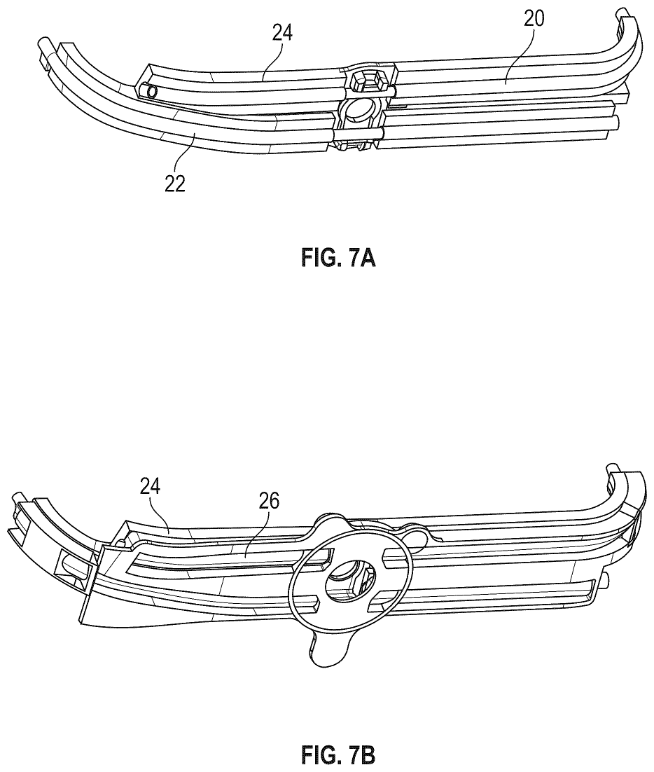

Referring now to at least FIG. 6 and in an alternative embodiment, the cables 6 and 7 are received with tubes 20, 22 secured to the glove box surround 1. Referring now to at least FIGS. 7A and 7B, no tubes are used and the cable 6 and 7 are secured to a cable race in a structure 24 that secured to the glove box surround 1 and the structure is covered with a shroud 26.

As illustrated in at least FIGS. 7A and 7B, and in one embodiment, the cable races are packaged directly in a two piece support structure that is separate from the glove box surround to allow it to be isolated for noise if required.

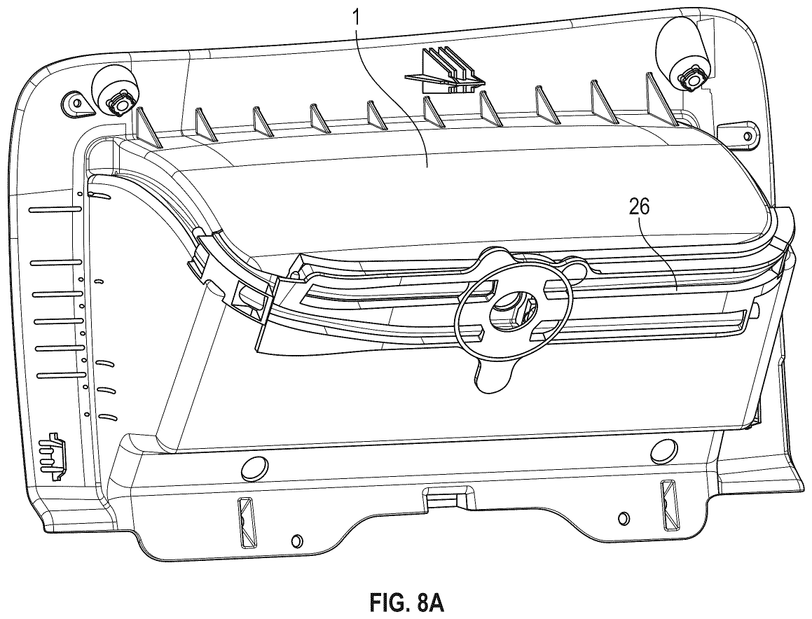

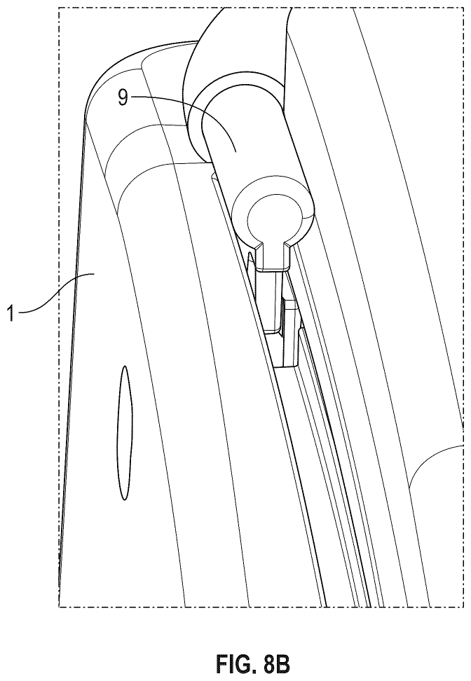

FIGS. 8A and 8B illustrates that the cable race sub-assembly of FIGS. 7A and 7B, is then installed to the glove box sub-assembly and the cable tabs are engaged to the glove box.

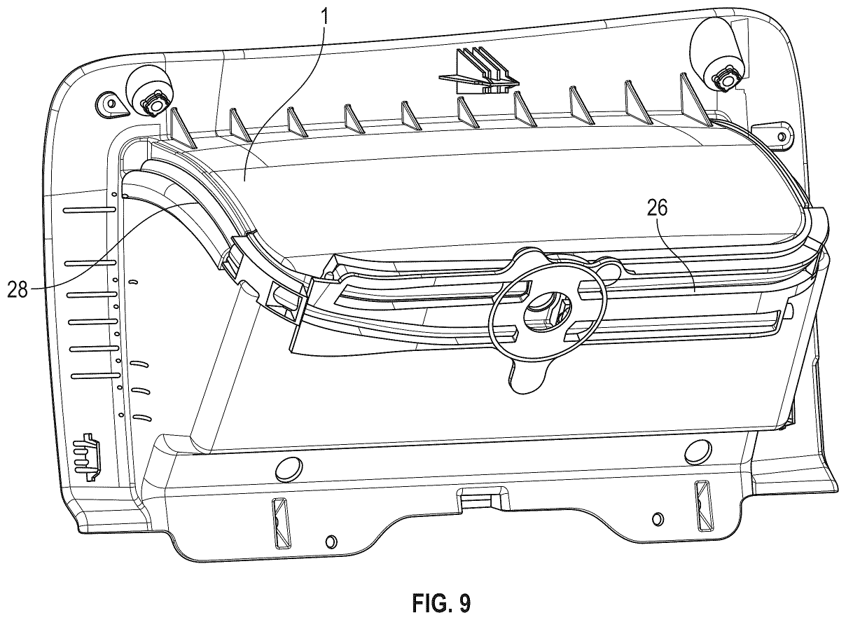

Referring now to FIG. 9 and when the tabs engaged, side cable covers 28 can be installed to secure the tab to box alignment.

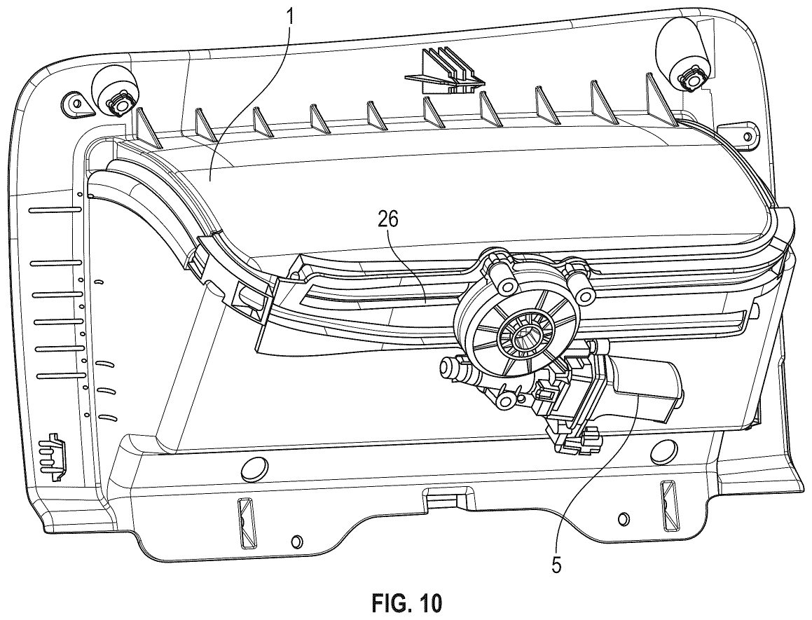

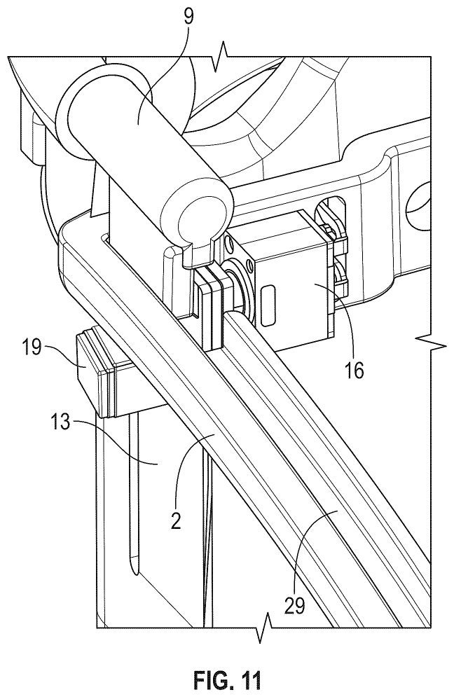

In FIG. 10, the motor 5 is installed since the cables are properly aligned. The motor 5 is configured to drive a worm that drives a cable drum that is operably coupled to cables 6 and 7. In one embodiment, the cables are configured to be driven by a gear 30 that is driven by the motor 5. Of course alternative cable driving arrangements are contemplated to be with the scope of the present disclosure. In FIG. 11, the tabs 13 must hold the motor stall force (cinch force) and also be able to allow the glove box to disengage from them to allow manual closing and obstacle detection while opening, this is accomplished with a flexible engagement tab on the glove box.

When manually closed, the glove box must “latch” into a secondary position with an acceptable closing force, also accomplished with the tuned flexible engagement tab and a tab on the glove box surround.

When the tab disengages from the glove box, a microswitch signals the motor to close the glove box, this will cause the motor to move the cable and cinch the box from the secondary position to the primary position this cinching also disengages the flexible engagement tab from the glove box surround to allow for the next glove box open signal.

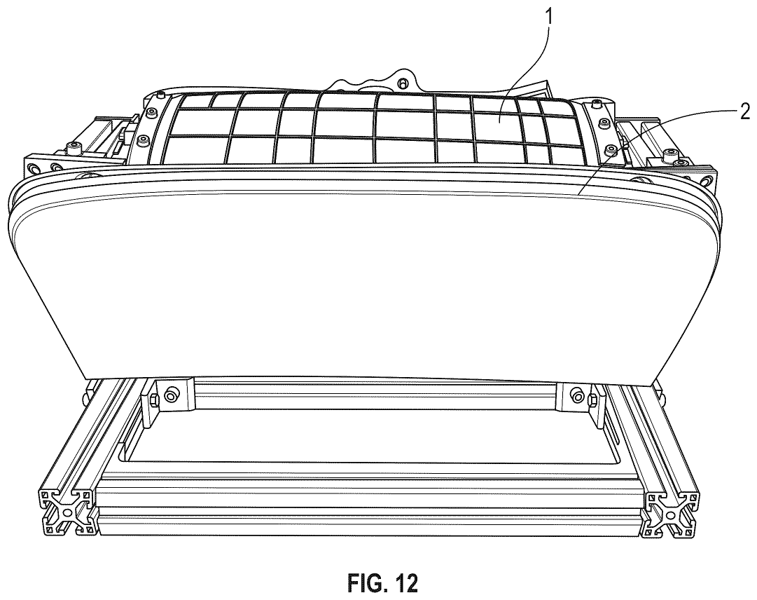

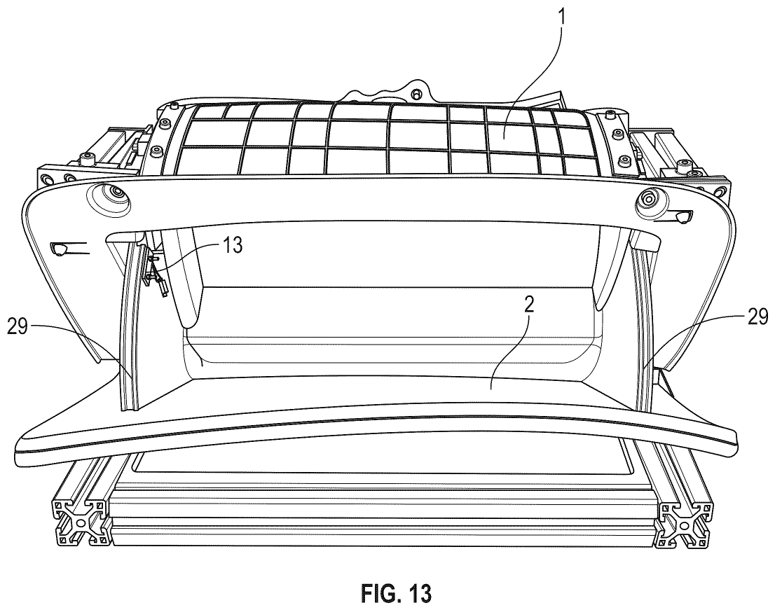

FIG. 12 illustrates the vehicle glove box assembly in a closed position and FIG. 13 illustrates the vehicle glove box assembly in an open position.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A vehicle glove box assembly, comprising:
a glove box surround;
a glove box compartment, the glove box compartment being pivotally mounted to the glove box surround for movement between a fully closed position where the glove box compartment is sealed against the glove box surround and a fully opened position where an internal volume of the glove box compartment is accessible and a secondary position wherein the glove box compartment is latched and located between the fully closed position and the fully opened position; and
a driving mechanism for moving the glove box compartment between the fully closed position and the fully opened position, the driving mechanism being a push/pull cable drive system.

2. The vehicle glove box assembly as in claim 1, wherein the push/pull cable drive system includes a pair of separate cables for moving the glove box compartment between the fully closed position and the fully opened position.

3. The vehicle glove box assembly as in claim 2, wherein the pair of separate cables control both ends of the glove box compartment simultaneously.

4. The vehicle glove box assembly as in claim 2, wherein at least one of the pair of separate cables has a cable end fitting configured to engage a flexible tab of the glove box compartment.

5. The vehicle glove box assembly as in claim 4, wherein the cable end fitting has an angled surface to configured to engage an angled surface of the flexible tab of the glove box compartment.

6. The vehicle glove box assembly as in claim 5, further comprising a switch configured to be actuated by the flexible tab of the glove box compartment.

7. The vehicle glove box assembly as in claim 2, wherein the pair of separate cables each have a cable end fitting configured to be slidably received within a groove of the glove box compartment.

8. The vehicle glove box assembly as in claim 2, wherein at least one of the pair of separate cables has a cable end fitting configured to engage a flexible tab of the glove box compartment and the flexible tab has a protruding portion configured to engage a closing tab of the glove box surround.

9. The vehicle glove box assembly as in claim 8, wherein the cable end fitting has an angled surface to configured to engage an angled surface of the flexible tab of the glove box compartment.

10. The vehicle glove box assembly as in claim 9, wherein the protruding portion and the angled surface are located on opposite sides of the flexible tab.

11. The vehicle glove box assembly as in claim 2, wherein the pair of separate cables are received within a cable race of a structure that secured to the glove box surround.

12. The vehicle glove box assembly as in claim 11, wherein the structure and the pair of separate cables are covered with a shroud.

13. The vehicle glove box assembly as in claim 12, wherein the pair of separate cables control both ends of the glove box compartment simultaneously.

14. The vehicle glove box assembly as in claim 13, wherein at least one of the pair of separate cables has a cable end fitting configured to engage a flexible tab of the glove box compartment.

15. The vehicle glove box assembly as in claim 14, wherein the cable end fitting has an angled surface to configured to engage an angled surface of the flexible tab of the glove box compartment.

16. The vehicle glove box assembly as in claim 15, further comprising a switch configured to be actuated by the flexible tab of the glove box compartment.

17. The vehicle glove box assembly as in claim 12, wherein the pair of separate cables control both ends of the glove box compartment simultaneously and the pair of separate cables each have a cable end fitting configured to be slidably received within a groove of the glove box compartment.

18. The vehicle glove box assembly as in claim 17, wherein the cable end fitting of at least one of the pair of separate cables is configured to engage a flexible tab of the glove box compartment and the flexible tab has a protruding portion configured to engage a closing tab of the glove box surround.

19. The vehicle glove box assembly as in claim 18, wherein the cable end fitting the cable end fitting of at least one of the pair of separate cables has an angled surface to configured to engage an angled surface of the flexible tab of the glove box surround.

20. The vehicle glove box assembly as in claim 19, wherein the protruding portion and the angled surface are located on opposite sides of the flexible tab.
